(19) United States
(12) Patent Application Publication
(10) Pub. No.: US 2024/0401879 A1
(43) Pub. Date: Dec. 5, 2024

(54) TREATMENT SYSTEM AND METHOD FOR TREATING WORKPIECES

(71) Applicant: DÜRR SYSTEMS AG, Bietigheim-Bissingen (DE)

(72) Inventors: Heiko DIETER, Besigheim (DE); Sören WEHLER, Bönnigheim (DE); Kevin WOLL, Heilbronn (DE); Jonas WEIDMANN, Stuttgart (DE)

(21) Appl. No.: 18/696,815

(22) PCT Filed: Sep. 30, 2022
(86) PCT No.: PCT/DE2022/100730

§ 371 Date: Mar. 28, 2024

(30) Foreign Application Priority Data
Sep. 30, 2021 (DE) 10 2021 211 018.5

(51) Int. Cl. F26B 15/12; F26B 3/04; F26B 21/00

(52) U.S. Cl. CPC F26B 15/12; F26B 3/04; F26B 21/004; F26B 2210/12

(57) ABSTRACT

The invention relates to a treatment system having a treatment line which comprises a single-part or multi-part drying chamber for drying and/or curing coated workpieces, optionally vehicle bodies. An at least two-part drying conveyor device is provided which extends along an at least two-part drying conveyor portion, the drying conveyor portion having at least two conveyor sub-portions, the first conveyor sub-portion having a first conveyor sub-device which is designed as a longitudinal conveyor device, and the second conveyor portion having a second conveyor sub-portion which is designed as a transverse conveyor device. The invention further relates to a treatment method.

### RELATED APPLICATION

This application is a national phase of international application No. PCT/DE2022/100730 filed on Sep. 30, 2022, and claims the benefit of German application No. 10 2021 211 018.5 filed on Sep. 30, 2021, which are incorporated herein by reference in their entirety and for all purposes.

### BACKGROUND

The present disclosure relates to a treatment system and a method for treating workpieces. A treatment system can optionally be a drying system that is attached to and/or connected to a painting system for painting workpieces, for example vehicle bodies. A treatment system optionally comprises a drying device and may further comprise one or more treatment rooms for performing treatment steps.

### SUMMARY

The object of examples disclosed herein is to provide a treatment system which has a simple and compact design and enables efficient, energy-saving workpiece treatment.

According to examples disclosed herein, this object is achieved by a treatment system in accordance with the independent device claim.

Further, the object of examples disclosed herein is to provide a method for the treatment of workpieces by means of which an efficient and energy-saving workpiece treatment is made possible using a simple and compactly constructed treatment system.

This object is achieved according to examples disclosed herein with the features of the independent method claim.

A treatment system has, for example, a treatment line with a single-part or multi-part drying room for drying and/or curing coated workpieces, which optionally have a larger longitudinal extension and a smaller transverse extension in comparison, optionally vehicle or motor vehicle bodies, vehicle chassis or similar.

The treatment system, optionally the treatment line, preferably comprises an at least two-part drying conveyor device which extends along an at least two-part drying conveyor path, wherein the drying conveyor path comprises at least two partial conveyor paths, wherein a first partial conveyor path comprises a first partial conveyor device which is designed as a longitudinal conveyor device and a second partial conveyor path comprises a second partial conveyor device which is designed as a transverse conveyor device.

A longitudinal conveying device is preferably understood to mean that the workpiece is held and conveyed on the conveying device at least approximately parallel to a main conveying direction in relation to a longitudinal extension of the same. By analogy, a transverse conveying device is preferably understood to mean that the workpiece is held and conveyed transversely, optionally at least approximately perpendicularly, to a main conveying direction on the conveying device in relation to a longitudinal extension of the same.

In accordance with an alternative embodiment, it may be provided that the drying conveyor path comprises a third partial conveyor path, which has a third partial conveyor device, wherein the third partial conveyor device is designed, for example, as a longitudinal conveyor device.

The described conveyor paths and/or partial conveyor paths are preferably always designed to be enclosed and/or enclosed. Preferably, entrances and exits, transition openings, airlocks, etc. are provided to enable the optionally continuous transportation of workpieces.

It can be advantageous if a sluice device, for example an inlet or outlet sluice, and/or a barrier, for example a mechanical and/or openable and/or closable barrier, is arranged between two treatment rooms and/or adjacent to an intermediate treatment room. Alternatively or additionally, it may be provided that a sluice device, for example an outlet sluice, and/or a barrier, for example mechanical and/or openable and/or closable, is arranged between the intermediate treatment room and a treatment room.

A barrier is optionally a high-speed door, a sectional door, a sliding door or an up-and-over door.

By means of the one or more sluice devices, the respective treatment room and/or the intermediate treatment room can preferably be separated from its environment by means of fluid technology, for example in order to more easily maintain a higher or lower temperature in the respective interior space compared to the environment. The workpieces can preferably be conveyed through the inlet sluice by means of the first conveyor device. The first conveyor device can extend through the inlet sluice, for example.

One or more cooling areas for cooling the workpieces are preferably provided downstream or upstream of the outlet sluice. For example, a single cooling tunnel and/or cooling room can be provided for all workpieces.

In a further embodiment, a fourth partial conveyor path with a fourth partial conveyor device is provided in the drying conveyor path, wherein the fourth partial conveyor device is designed as a transverse conveyor device, wherein the fourth partial conveyor device is optionally arranged in a space designed as a cooling tunnel or cooling room.

Advantageously, the treatment system is arranged on two vertically spaced-apart horizontal levels, for which purpose advantageously at least one lifting system for workpieces is provided in order to transfer workpieces from a, optionally lower, first level to a, optionally upper, second level. For this purpose, the at least one lifting system is optionally
a) a part of the first partial conveyor device and/or
b) a part of the second partial conveyor device and/or
c) a part of the third partial conveyor device and/or
d) a part of the fourth partial conveyor device
   or designed adjacent to it.

In a further advantageous embodiment of the treatment system, the latter has at least two treatment lines, each with a drying room, wherein partial conveyor devices of the treatment lines designed as longitudinal conveyor devices are aligned parallel or largely parallel to one another and at least two partial conveyor devices designed as transverse conveyor devices are arranged in a common partial portion of the at least two drying rooms. In other words, the common partial portion preferably forms a common drying room or drying tunnel portion in which transverse conveyor devices of two or more treatment lines are arranged, optionally aligned and/or aligned with or towards one another.

In a further improved and optionally compact design of the treatment system, it may be provided that the at least two of the partial conveyor devices designed as transverse conveyor devices are arranged on two vertically spaced levels. Optionally, one of the transverse conveyor devices is provided in a cooling area, optionally a treatment room designed as a cooling room or cooling tunnel.

Advantageously, the common partial portion of the drying room, in which a plurality of transverse conveyor devices are arranged, has at least one partition or section wall, with which the common partial portion of the respective drying room can preferably be subdivided or partitioned off, optionally in order to delimit one treatment line from an adjacent treatment line.

A further improvement can be that at least one sluice is provided in the treatment system, which is arranged before the first partial conveyor device designed as a longitudinal conveyor device; and/or after a last partial conveyor device designed as a longitudinal conveyor device.

In an advantageous embodiment of the treatment system, the partial transport device designed as a transverse conveyor device has at least one transition module as an input module, into which a workpiece can be introduced oriented in the longitudinal direction and can be transported out and/or on along the partial conveyor path oriented in the transverse direction. Additionally or alternatively, the treatment system can have a transition module as an output module, into which a workpiece can be inserted oriented in the transverse direction and can be transported out and/or onward oriented in the longitudinal direction. Here, the input module or the output module preferably forms part or the only part of a longitudinal conveyor device.

Preferably, in the treatment system for drying workpieces, the following is arranged upstream of the drying room with respect to the conveying direction:
a first treatment room for performing a first treatment step on the workpieces;
a second treatment room for performing a second treatment step on the workpieces;
an intermediate treatment room for implementing an intermediate treatment between the first treatment step and the second treatment step;
a conveyor system by means of which the workpieces can be removed from the first treatment room, passed through the intermediate treatment room and/or fed to the second treatment room.

Advantageously, the drying room is arranged as a third treatment room after the at least one second treatment room with respect to the conveying direction, wherein one or more treatment devices for treating the workpieces are preferably assigned to the third treatment room,
a) wherein, for example, one or more nozzles are provided as a treatment device for flowing a tempered gas stream, for example air, onto the workpieces; and/or
b) wherein the workpieces are treated or can be treated by exposing them to a tempered gas stream, for example air, wherein the tempered gas stream or the air is supplied or can be supplied to the workpieces via a filter ceiling and/or via a plenum, wherein optionally the tempered gas stream supplied in this manner, for example air, is discharged or can be discharged preferably via a bottom-side extraction system.

A further improvement can be that a cooling area, optionally a cooling room, a cooling tunnel or a cooling zone, is provided after the drying room as the third treatment room and/or as a component of the drying room. Optionally, air outlets, nozzles or similar are provided for supplying the workpieces with a tempered gas flow, for example a heated gas flow and/or a cooled gas flow, optionally air, wherein the gas flow supplied to the cooling area in this manner is preferably discharged or can be discharged via an extraction system on or near the floor.

In a further alternative embodiment, a rotation device can be provided before the drying room and after the second treatment room and/or after the end of the second conveyor device and/or the second conveyor path, by means of which a workpiece can be rotated from a longitudinal orientation to a transverse orientation. This rotation device is usually only required if a workpiece is to be introduced into a treatment room and/or drying room in a transverse orientation.

In a further advantageous embodiment of the treatment system, the conveyor system preferably comprises a first conveyor device for conveying the workpieces along a first conveyor path through the first treatment room and/or out of the first treatment room. In this case, the first conveyor device can be designed as a rail or chain conveyor and have at least one holding and/or carrying device for a workpiece, optionally a plurality of holding and/or carrying devices for one workpiece each. Preferably, the first conveyor device comprises at least one endlessly circulating, motor-driven conveyor chain. Alternatively, it may be provided that the first conveyor device comprises at least one autonomous and/or self-propelled transport vehicle for moving the at least one holding and/or carrying device.

Alternatively or additionally, the conveyor system may comprise a second conveyor device for conveying the workpieces along a second conveyor path into the second treatment room and/or through the second treatment room. The second conveyor device can be designed as a rail or chain conveyor and have at least one holding and/or carrying device for a workpiece, optionally a plurality of holding and/or carrying devices for one workpiece each. This may comprise at least one endlessly circulating, motor-driven conveyor chain. Alternatively, it may be provided that the second conveyor device comprises at least one autonomous and/or self-propelled transport vehicle for moving the at least one holding and/or carrying device.

It may be provided that one or more treatment devices and/or treatment units are provided in the first and/or second treatment room, by means of which one or more of the following processes can be carried out as a treatment step: coating, painting, cleaning, heating and/or cooling of the workpieces.

Alternatively or additionally, it may be provided that after the, optionally final, drying device, optionally the drying in the third treatment room, one or more treatment devices and/or treatment units are provided, by means of which one or more of the following operations can be carried out as a treatment step: processing of the workpieces, further processing of the workpieces and/or mounting of additional components on the workpieces, optionally for starting or performing a final assembly of objects to be manufactured using the workpieces, for example motor vehicles.

It may be provided that the intermediate treatment room comprises one or more treatment devices and/or treatment units, by means of which one or more of the following processes can be carried out as an intermediate treatment step: heating, drying and/or cooling, but also processing, coating and/or painting of the workpieces as required.

Furthermore, the conveyor system can comprise an intermediate conveyor device by means of which the workpieces can be conveyed through the intermediate treatment room and/or from the first conveyor device to the second conveyor device. The intermediate conveyor device can be designed as a rail or chain conveyor and have at least one holding and/or carrying device for a workpiece, optionally a plurality of holding and/or carrying devices for one workpiece each. Preferably, the intermediate conveyor device comprises at least one endlessly circulating, motor-driven conveyor chain. Alternatively, it may be provided that the intermediate conveying device comprises at least one autonomous and/or self-propelled transport vehicle for moving the at least one holding and/or carrying device.

A portion of the intermediate conveyor path is, for example, an intermediate conveyor path segment. The main conveying direction of the conveyor system is optionally a direction along which the workpieces can be conveyed or are conveyed in the first treatment room and/or in the second treatment room.

The main conveying direction is, for example, a straight line that extends through an inlet of the first treatment room and an outlet of the second treatment room.

It may be provided that the conveyor path of the first conveyor device and the second conveyor path of the second conveyor device extend at least approximately parallel to one another.

Alternatively or in addition to this, it may be provided that the first conveyor path of the first conveyor device and the second conveyor path of the second conveyor device extend at least approximately parallel to a main conveying direction of the conveyor system and/or predetermine this, for example jointly.

Further, alternatively or additionally, it may be provided that the first conveyor path of the first conveyor device and the second conveyor path of the second conveyor device are arranged consecutively and/or in alignment with one another along a main conveying direction of the conveyor system.

The first conveyor path of the first conveyor device and the second conveyor path of the second conveyor device are optionally arranged at a distance from one another and/or connected to one another by means of the intermediate conveyor path.

It can be favorable if the second conveyor path of the second conveyor device is arranged in direct extension of the first conveyor path of the first conveyor device, wherein, for example, a distance is provided between the two conveyor paths.

In this description and the appended claims, the term “second conveyor path” preferably refers to a totality of the conveyor path of the second conveyor device. Accordingly, the second conveyor device preferably has no additional “first conveyor path”.

Accordingly, the first conveyor path of the first conveyor device is preferably the only conveyor path of the first conveyor device.

The first conveyor device, the second conveyor device and/or the intermediate conveyor device are designed, for example, as one or more longitudinal conveyor devices in which a longitudinal workpiece axis of the transported or to-be-transported workpieces is arranged at least approximately parallel to the main conveying direction of the conveyor system and/or parallel to the local conveying direction of the respective conveyor device.

Alternatively, it may be provided that the first conveyor device, the second conveyor device and/or the intermediate conveyor device each comprise one or more longitudinal conveyor devices.

A further embodiment provides for the workpieces to be conveyed at least in portions along an intermediate conveyor path by means of the intermediate conveyor device, which extends at least in portions
at least approximately parallel to the first conveyor path of the first conveyor device;
and/or at least approximately parallel to the second conveyor path of the second conveyor device; and/or is arranged offset to the first conveyor path of the first conveyor device and/or to the second conveyor path of the second conveyor device in a transverse direction extending perpendicular to a main conveying direction of the conveyor system, and wherein at least one transverse conveyor device is provided, by means of which a workpiece can be transferred from the first conveyor device to the intermediate conveyor device and/or a longitudinal conveyor device; and/or by means of which a workpiece can be transferred from the intermediate conveyor device to the second conveyor device.

For example, it may be provided that the intermediate conveyor device comprises an intermediate conveyor path, which comprises intermediate conveyor path segments arranged in a U-shape. Optionally, it may be provided that two or more intermediate conveyor path segments extending parallel to one another are provided, which form legs of equal length or different lengths of a U-shaped intermediate conveyor path. An intermediate conveyor path segment connecting the two legs is aligned and/or arranged parallel to the main conveying direction, for example.

Further, it may be provided that the intermediate conveyor system comprises an intermediate conveyor path which has a double U-shape and, optionally, extends in a direction transverse to the main conveying direction of the conveyor system to both sides of the first conveyor path and/or the second conveyor path.

Advantageously, the holding and/or carrying device of the first conveyor device is arranged on and/or has a rotating and tilting unit for workpieces. Optionally, the turning and tilting unit is designed to rotate the workpieces, for example by at least 180°, about a horizontal axis of rotation. The axis of rotation is preferably aligned in the transverse direction and enables the workpieces to be conveyed over a partial path in an orientation rotated by 180°, for example. Alternatively or additionally, the holding and/or carrying device of the second conveyor device may be arranged on and/or have a rotating and tilting unit for workpieces. Optionally, the turning and tilting unit can be used to rotate the workpieces by at least 180° around a horizontal axis of rotation, for example. For this purpose, it is aligned in an analogous manner in the transverse direction and is used to convey the workpieces over a partial path in an orientation rotated by 180°, for example.

An improvement consists in that the first conveyor path of the first conveyor device and the second conveyor path of the second conveyor device extend parallel to one another; and/or extend parallel to a main conveying direction of the conveyor system and/or predetermine this, for example jointly. Alternatively or additionally, the first conveyor path of the first conveyor device and the second conveyor path of the second conveyor device may be arranged consecutively and/or in alignment with one another along a main conveying direction of the conveyor system. It can be advantageous if the first conveyor device extends into the intermediate treatment room, for example linearly along the main conveying direction of the conveyor system.

In one embodiment, it is provided that the intermediate conveyor device comprises an intermediate conveyor path which comprises a plurality of intermediate conveyor path segments extending transversely to one another. An additional improvement here is that a transverse conveyor device is provided between the end of the first conveyor device and the beginning of the intermediate conveyor device or a longitudinal conveyor device.

Alternatively or additionally, a transverse conveyor device can be provided at the end of the intermediate conveyor device and the beginning of the second conveyor device.

In a further embodiment, the treatment system comprises at least one coating device, which is arranged in the first treatment room and is used for performing a coating process for treating the workpieces. This coating device in the first treatment room is designed as a spray painting device, optionally as a spray painting device having spraying and/or painting robots. Alternatively or additionally, the treatment system may comprise at least one coating device, which is arranged in the second treatment room and is used for performing a coating process for treating the workpieces. This coating device in the second treatment room is designed as a spray painting device, optionally as a spray painting device having spraying and/or painting robots. Here, the intermediate treatment room can be or comprise a tempering and/or drying room for tempering and/or drying the workpieces.

A spray painting device is optionally a painting device in which a coating is applied by means of an applicator. “Spraying” can be either an atomization or a jet application. Spray painting is optionally in contrast to dip coating.

A further alternative embodiment provides that the treatment system comprises at least one pre-treatment device, which is arranged in the first treatment room or is arranged upstream of the first treatment room with respect to the conveying direction and serves to perform a pre-treatment of the workpieces. The pre-treatment device is, for example, a cleaning device, a degreasing device and/or a phosphating device. Alternatively or additionally thereto, at least one coating device may be provided, which is arranged in the second treatment room and serves to perform a coating process for treating the workpieces, wherein the coating device in the second treatment room is a spray painting device, optionally a spray painting device having spray and/or painting robots. Furthermore, a tempering and/or drying room for tempering and/or drying the workpieces may additionally or alternatively be provided in an intermediate treatment room or be designed as such.

According to a further alternative embodiment, the treatment system comprises at least one coating device, which is arranged in the first treatment room and is used for performing a coating process for treating the workpieces. Here, the coating device in the first treatment room is a spray painting device, optionally a spray painting device having spraying and/or painting robots. Additionally or alternatively, at least one coating device is provided, which is arranged in the second treatment room and is used for performing a coating process for treating the workpieces. Here, the coating device in the second treatment room is a spray painting device, optionally a spray painting device having spraying and/or painting robots. The spray painting device in the first treatment room is optionally used to apply a base coat. The spray coating device in the second treatment room is optionally used to apply a clear coat.

A further alternative embodiment provides that at least one coating device is arranged in the first treatment room and/or in the second treatment room and is used for performing a coating process for treating the workpieces, wherein this is a spray coating device. The spray painting device can optionally be a spray painting device having at least one spraying and/or painting robot. For effective conversion of color changes and metering of coating fluids in the line paths, the first and/or second coating device is advantageously connected to a metering and preparation unit for at least two coating fluids, optionally also to a storage and buffer system for coating fluids.

The conveying and/or transportation of the workpieces in the treatment system can take place continuously or in partial portions or partial paths thereof, or as cyclical or step conveying.

It can be favorable if several cyclic positions and/or holding positions for temporary positioning of the workpieces are arranged in an (intermediate) treatment room, optionally in a cyclic operation of an (intermediate) conveyor device.

One or more of the cyclic positions and/or holding positions are preferably each assigned one or more treatment devices for treating the workpieces, for example one or more nozzles for supplying the workpieces with a stream of gas, for example at a controlled temperature.

Further, treating the workpieces in such a manner can preferably also be provided independently of cyclical conveying of the workpieces.

As an alternative or in addition to cyclical conveying, the conveyor devices can further be coordinated in different, optionally parallel, treatment rooms (so-called line-tracking) and/or conveyor devices that are controlled and/or designed differently in terms of conveyor speed.

A cyclic position is, for example, a position in which the workpieces are stopped in a cycle conveyor of the same for implementing a treatment step and/or for temporary bearing of the same.

A holding position, for example, is a position in which the workpieces are brought to a temporary standstill, regardless of the type of conveying (intermittent or continuous conveying).

In another alternative embodiment, the intermediate treatment room comprises a plurality of cyclic positions and/or holding positions for temporarily positioning the workpieces. One or more treatment devices for treating the workpieces are assigned to one or more of the cyclic positions and/or holding positions. These can be, for example, one or more nozzles for supplying the workpieces with a tempered air or gas flow, wherein the air or gas supplied in this manner is preferably extracted or can be extracted via an extraction system on or near the floor.

A further alternative embodiment provides that a sluice device and/or a barrier is arranged between the first treatment room and the intermediate treatment room and/or between the intermediate treatment room and the second treatment room. The barrier can be a mechanical and/or openable and/or lockable barrier.

A further alternative embodiment provides that the sluice device, which is arranged between the first treatment room and the intermediate treatment room and/or which is arranged between the intermediate treatment room and the second treatment room, is a longitudinal sluice device through which the workpieces can be conveyed in a longitudinal orientation thereof. Optionally, the sluice device and/or barrier can be adjusted or adapted to the outer contour of the workpieces in the open state.

The one or more sluice devices are preferably designed in such a manner that the workpieces can be conveyed through the respective sluice device in the longitudinal orientation thereof. Optionally, an opening cross-section of the respective sluice device as mentioned above can be adapted to a conveying contour of the workpieces during longitudinal conveying of the same. The conveying contour of the workpieces is preferably the outer contour of the spatial area which is swept by the workpieces during longitudinal conveying of the workpieces.

For example, for the optimum extension of coating fluid on a workpiece, a further alternative embodiment provides that a cooling area is provided after the intermediate treatment room and before the second treatment room or as a component of the intermediate treatment room. This can be designed as a cooling room or a cooling zone or as a cooling tunnel, in which nozzles are optionally provided for flowing a tempered gas stream, for example a heated gas stream and/or a cooled gas stream, optionally air, onto the workpieces. Preferably, the gas flow supplied in this manner is extracted via an extraction system on or near the floor.

It can be advantageous if the workpieces are or can be treated in the intermediate treatment room, optionally immediately after an inlet sluice, by exposing them to tempered air. The tempered air is supplied to the workpieces via a filter ceiling and/or a plenum or can be supplied in this manner. The air supplied in this manner is preferably extracted via a floor-side or near-floor extraction system or can be extracted via corresponding outlets.

A feed speed by means of which the tempered air can be or is introduced into the intermediate treatment room is preferably less than 5 m/s, optionally less than 1 m/s. This can preferably minimize the pressure acting on the inlet sluice in order not to impair the sluice effect of the inlet sluice or to impair it as little as possible.

It can be favorable if the intermediate treatment room comprises several areas in which the workpieces are or can be treated by exposing them to tempered air, wherein the tempered air is preferably supplied or can be supplied to the workpieces via a filter ceiling and/or via a plenum. Alternatively or additionally, it can also be fed laterally via at least one nozzle.

Advantageously, the treatment system comprises two or more than two first treatment rooms, each of which is assigned to a treatment line. A single intermediate treatment room is assigned to these two treatment rooms, for example downstream with respect to the conveying direction, wherein this is an intermediate treatment room arranged optionally centrally between two first treatment rooms.

It may be provided that the treatment system comprises two or more than two inlet sluices through which the workpieces can be conveyed into the intermediate treatment room. Alternatively or additionally, the treatment system may have a single outlet sluice through which the workpieces can be conveyed out of the intermediate treatment room.

It can be favorable if the sluice device, which is arranged between the first treatment room and the intermediate treatment room, and/or the sluice device, which is arranged between the intermediate treatment room and the second treatment room, is a longitudinal sluice device through which the workpieces can be conveyed in a longitudinal orientation thereof.

The longitudinal alignment of the workpieces is optionally the alignment of the workpieces in such a manner that a longitudinal axis of the workpieces extends parallel to the conveying direction of the workpieces, optionally a local conveying direction of the workpieces.

Alternatively or additionally, the conveyor system may comprise a combining device by means of which the workpieces from several first treatment rooms can be brought together and fed to a common conveyor path segment. This can be, for example, an intermediate conveyor path segment of an intermediate conveyor path, wherein the combining device is arranged, for example, within the intermediate treatment room.

In order to forward workpieces from a central intermediate conveyor device, a further alternative embodiment provides that the conveyor system comprises a distribution device. This can be used to distribute the workpieces from an intermediate treatment room, for example from an intermediate conveyor path segment of an intermediate conveyor path, to several second treatment rooms.

The intermediate treatment room is optionally an intermediate treatment room arranged centrally between two second treatment rooms. Similarly, the intermediate conveyor path is optionally an intermediate conveyor path arranged centrally between two second treatment rooms.

One or more first treatment rooms and/or one or more second treatment rooms and/or one or more intermediate treatment rooms are arranged and/or designed, for example, as flow-through cabins.

Alternatively or additionally, it may be provided that one or more first treatment rooms and/or one or more second treatment rooms and/or one or more intermediate treatment rooms are arranged and/or designed as treatment boxes.

In one embodiment of examples disclosed herein, it may be provided that a drying conveyor path is designed to be substantially annularly closed, wherein the workpieces are fed and discharged at least approximately adjacent to one another.

The drying conveyor path comprises, for example, a first partial conveyor path, a second partial conveyor path and a third partial conveyor path, wherein all three partial conveyor paths are arranged parallel to one another and/or wherein the first partial conveyor path and the second partial conveyor path are adjacent to one another and/or have a common main axis of extension.

Here, it is optionally provided that an inlet area or feed area, optionally an inlet sluice, for feeding workpieces to the first partial conveyor path is arranged at an end of the first partial conveyor path facing the third partial conveyor path.

Alternatively or in addition to this, it may be provided that an outlet area or discharge area, optionally an outlet sluice, for discharging workpieces from the third partial conveyor path is arranged at an end of the third partial conveyor path facing the first partial conveyor path.

It can be favorable if the first partial conveyor path is part of a pre-dryer or forms a pre-dryer; and/or if the second partial conveyor path is part of a main dryer or forms a main dryer; and/or if the third partial conveyor path is part of a cooling area, optionally a cooling zone, or forms a cooling area, optionally a cooling zone.

The drying conveyor path is preferably dimensioned in such a manner that a total length of the first partial conveyor path plus a total length of the third partial conveyor path corresponds at least approximately to a total length of the second partial conveyor path. Optionally, the total length of the first partial conveyor path plus the total length of the third partial conveyor path is at least approximately 70%, for example at least approximately 85%, and/or at most approximately 100%, for example at most approximately 95%, of the total length of the second partial conveyor path.

The inlet area or feed area, optionally the inlet sluice, for feeding workpieces to the first partial conveyor path and the outlet area or discharge area, optionally the outlet sluice, for discharging workpieces from the third partial conveyor path are preferably arranged directly next to one another and/or consecutively with respect to a conveying direction of the workpieces in the first partial conveyor path and/or the third partial conveyor path.

The workpieces are preferably fed to the first partial conveyor path and/or removed from the third partial conveyor path in a direction that is at least approximately perpendicular to a conveying direction of the workpieces in the first partial conveyor path and/or the third partial conveyor path.

The workpieces are preferably conveyed in the first partial conveyor path, the second partial conveyor path and the third partial conveyor path in a transverse orientation.

The conveying directions in the first partial conveyor path and the third partial conveyor path are preferably parallel to each other and/or in the same direction, while the conveying direction in the second partial conveyor path is preferably antiparallel and/or in the opposite direction.

A sluice device, optionally an intermediate sluice, can optionally be arranged between the first partial conveyor path and the second partial conveyor path.

Further, a sluice device, optionally an intermediate sluice, can optionally be arranged between the second partial conveyor path and the third partial conveyor path.

In a further arrangement, a flash-off conveyor path can also be arranged directly next to the first partial conveyor path and/or antiparallel to it. This can lead to a optionally compact design.

Examples disclosed herein further relate to a method for drying and/or curing coated workpieces which optionally have a larger longitudinal extension and a smaller transverse extension in comparison thereto, optionally vehicle bodies, vehicle chassis or similar. Here, a treatment system according to examples disclosed herein is preferably used for the final drying step or the final drying method.

A “final drying step or method” is preferably to be understood as the drying step or method which is performed after the workpiece has undergone a final full-surface or largely full-surface coating with a liquid or flowable coating fluid.

An improved method variant can be that the workpieces are coated at least partially, optionally over the entire surface, and/or at least once with at least one coating fluid.

The coating can be applied in a dipping method step and/or a spraying method step.

In a further improved method variant, it may be provided that the method comprises the following steps:
a) performing a first treatment step on the workpieces in a first treatment room;
b) performing a second treatment step on the workpieces in a second treatment room;
c) performing an intermediate treatment between the first treatment step and the second treatment step in an intermediate treatment room,
   wherein the workpieces are removed from the first treatment room by means of a conveyor system, passed through the intermediate treatment room and/or fed to the second treatment room.

An extended method variant provides that, prior to implementing the first treatment step in the first treatment room, a pretreatment step is performed on the workpiece, wherein the pretreatment step comprises at least one of the following steps: cleaning, degreasing and/or phosphating.

It can be favorable if the final drying step or the final drying method takes place in several partial steps or partial drying steps, wherein these comprise, for example, a warming step, a heating or holding step and a cooling step, wherein the workpiece is optionally exposed to tempered and/or treated air. Each of the sub-steps mentioned can in turn be divided into two or more sub-steps, optionally in the case of cyclical conveying or cyclic operation of the workpieces.

It may be necessary to reduce the flow speed at the beginning of the drying step in order to improve the paint flow and reduce the amount of dirt swirled up. After the initial drying or curing of the coating, there is a subsequent change to higher gas speeds and temperatures, optionally for the most effective heating and drying of the workpiece.

It can be advantageous if the flow to the workpieces in the partial steps takes place at different flow speeds, optionally in the warming step at least for a partial path and/or partial duration with a flow speed of at least approximately 5 m/s and/or at most approximately 14 m/s and/or in the heating or holding step at least for a partial path and/or partial duration with a flow speed of at least approximately 15 m/s and/or at most approximately 25 m/s.

In a further improved process control, heating with a reduced temperature and heating gradient takes place in the drying step or in the sub-steps to improve the paint flow. For this purpose, it can be optionally advantageous if the following is provided in at least one sub-step of the drying step:
a) in the warming, at least for a partial path and/or partial duration, a heating air input with a temperature of at least approximately 100° C. and/or at most approximately 120° C., for example between 105° C. and 115° C.; and/or
b) in the heating or holding step, at least for a partial path and/or partial duration, heating air is introduced at a temperature of at least approximately 135° C. and/or at most approximately 155° C., for example between 140° C. and 150° C.

Preferably, the treatment system has one or more of the features and/or advantages described in connection with the method. Further, the method preferably has one or more of the features and/or advantages described in connection with the treatment system.

The functions described can be realized or are realized optionally by a suitable design and/or arrangement and/or controller and/or regulation of the treatment system. The associated control and regulation units are not shown or described in detail.

The terms used in this description and the appended claims, such as “for example”, “preferably”, “particularly”, etc., denote purely optional features and/or advantages of examples disclosed herein, which may be present or dispensable in individual embodiments according to examples disclosed herein. In no way do these terms designate features and/or advantages which may be regarded as essential to examples disclosed herein and thus limiting the scope of protection without a corresponding additional designation thereof.

Further preferred features and/or advantages of examples disclosed herein form the subject matter of the following description and the drawings illustrating exemplary embodiments.

### BRIEF DESCRIPTION OF THE DRAWINGS

FIG. 1 shows a schematic diagram of a treatment system for treating workpieces, designed for example as a painting system, which has a plurality of treatment lines;

FIG. 2 shows a schematic diagram of a system installation variant;

FIG. 3 shows an isolated representation of a first treatment line of the treatment system of FIG. 1, wherein an intermediate treatment room is provided between a first treatment room and a second treatment room;

FIG. 4 shows an isolated representation, corresponding to FIG. 2, of a second treatment line of the treatment system of FIG. 1, wherein an intermediate treatment room is provided between two first treatment rooms and two second treatment rooms;

FIG. 5 shows a schematic diagram of a second embodiment of a treatment system corresponding to FIG. 4;

FIG. 6 shows a schematic diagram of a further system installation variant of the treatment system;

FIG. 7 shows a schematic diagram of a further system installation variant of the treatment system;

FIG. 8 shows a schematic diagram of a further system installation variant of the treatment system;

FIG. 9 shows a schematic diagram of a further system installation variant of the treatment system;

FIG. 10 shows a schematic diagram of a further system installation variant of the treatment system;

FIG. 11 shows a schematic diagram of a further system installation variant of the treatment system;

FIG. 12 shows a schematic diagram of a further system installation variant of the treatment system;

FIG. 13 shows a schematic diagram of a further system installation variant of the treatment system;

FIG. 14 shows a schematic diagram of a further system installation variant of the treatment system; and

FIG. 15 shows a schematic diagram of an alternative design of a drying conveyor path.

The same or functionally equivalent elements are provided with the same reference signs in all figures.

### DETAILED DESCRIPTION

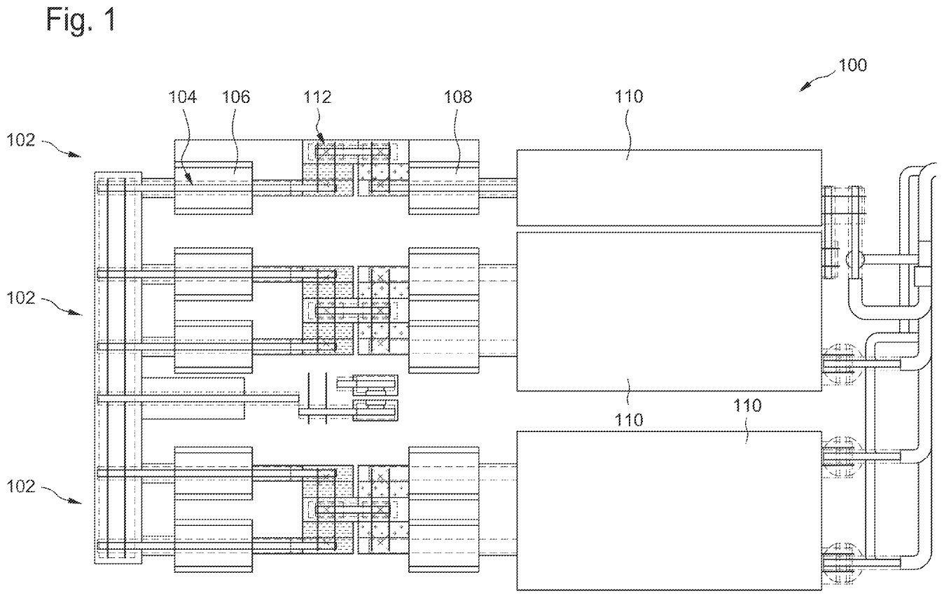

A first embodiment of a treatment system designated 100 as a whole, shown in FIG. 1, is used particularly for treating, for example coating, workpieces. The treatment system 100 is particularly a painting system.

As can be seen in FIG. 1, the treatment system 100 comprises, for example, a plurality of treatment lines 102 along which the workpieces are conveyed for implementing treatment steps.

For this purpose, the treatment system 100 comprises, in particular, a conveyor system 104, by means of which the workpieces can be conveyed through different treatment rooms 106, 108, 110, 112.

As can be seen from FIG. 1, different variants of treatment lines 102 are conceivable.

Each treatment line 102 may be provided independently of other treatment lines 102, so that the treatment system 100 as a whole may be formed by only a single treatment line 102 in various embodiments.

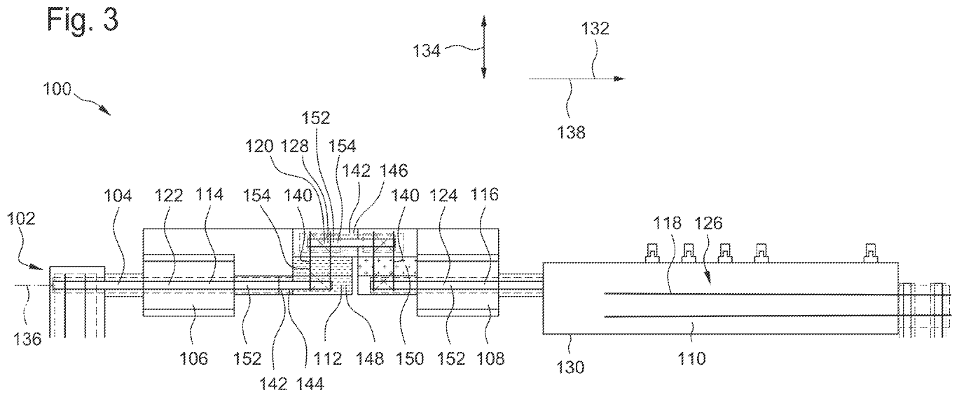

First, the embodiment of a treatment line 102 shown in FIG. 1 above, which is shown separately in FIG. 3, will be discussed.

This treatment line 102 in accordance with FIG. 3 comprises a first treatment room 106 in which, for example, a basecoat can be applied to a workpiece designed as a vehicle body. Further, a second treatment room 108, for example for applying a clear coat, and a drying room 110 are provided as a third treatment room, for example for performing a drying process.

Further, an intermediate treatment room 112 is preferably arranged between the first treatment room 106 and the second treatment room 108, which is for example an intermediate dryer.

The conveyor system 104 preferably extends through all treatment rooms 106, 112, 108, 110 and comprises a plurality of conveyor devices for this purpose.

In particular, the conveyor system 104 comprises a first conveyor device 114 associated with the first treatment room 106, a second conveyor device 116 associated with the second treatment room 108, a third conveyor device 118 associated with the third treatment room 110, and an intermediate conveyor device 120 associated with the intermediate treatment room 112.

Each conveyor device 114, 116, 118, 120 preferably forms a part of an overall conveyor section of the conveyor system 104.

The first conveyor device 114 forms a first conveyor path 122, the second conveyor device 116 forms a second conveyor path 124, the third conveyor device 118 forms a third conveyor path 126 and the intermediate conveyor device 120 forms an intermediate conveyor path 128.

The workpieces to be transported are particularly conveyable through the first treatment room 106 by means of the first conveyor device 114, then conveyable into the intermediate treatment room 112, therein transferable to the intermediate conveyor device 120 and finally transferable to the second conveyor device 116 in front of the second treatment room 108.

By means of the second conveyor device 116, the workpieces can be conveyed through the second treatment room 108 and finally transferred to the third conveyor device 118 in order to be conveyed through the drying room 110, the third treatment room.

For example, an overstroke and/or rotation device 130 may be arranged between the second conveyor device 116 and the third conveyor device 118 in order to change a line offset or an arrangement of the workpieces, for example a longitudinal alignment, before they are fed to the third treatment room 110, for example to change it to a transverse alignment.

In the longitudinal orientation of the workpieces, the workpieces are conveyed particularly along a main conveying direction 132 of the conveyor system 104. In a transverse orientation, a longitudinal axis of the workpiece is particularly at least approximately parallel to a transverse direction 134.

The main conveying direction 132 is particularly parallel to a longitudinal axis 136 of the treatment system 100 and/or the treatment line 102 and/or the conveyor system 104.

In particular, the main conveying direction 132 is at least approximately parallel to a main extension direction 138 of the treatment system 100, particularly the treatment line 102 and/or the conveyor system 104.

The transverse direction 134 is particularly substantially horizontal and perpendicular to the main conveying direction 132.

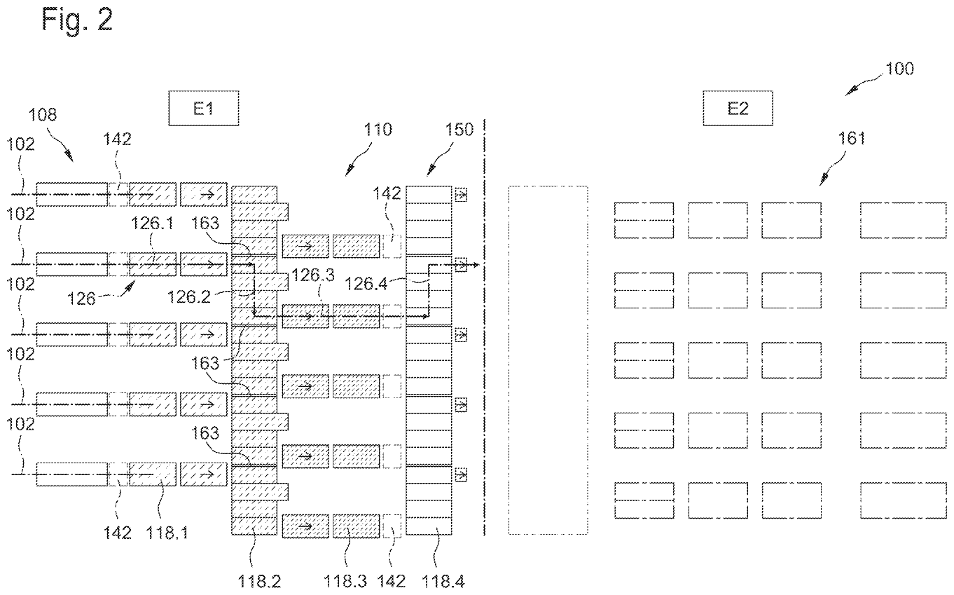

The treatment systems 100 shown in FIG. 2 and FIG. 6 to FIG. 14 are always represented with two levels, wherein a lower level is labeled E1 (left) and an upper level arranged above it is labeled E2 (right). In these exemplary embodiments, only the end or exit of the second treatment room 108 is shown throughout, wherein this may also correspond to the first and only treatment room 106 located upstream with respect to the conveying direction if an intermediate treatment room 112 and/or a further treatment room is omitted.

In all exemplary embodiments, the treatment system 100 comprises, for example, five treatment lines 102, wherein this is not to be understood as limiting. The treatment lines 102 are preferably constructed identically in the figures mentioned, unless something different is explicitly stated. In the following, only sluice devices 142 are referred to and no distinction is made between inlet and outlet sluices, as this distinction results from the main conveying direction.

In the example shown in FIG. 2, all or the majority of the supply and process elements 161 are arranged on the upper level E2, above the third conveyor device 118, which will be discussed in more detail below. The two levels E1 and E2 are distinguished from one another by the vertical dotted line. The supply and process elements 161 are, for example, fluid conveying units (compressors, pumps, etc.), heating and/or cooling units, valves and distribution units, heat exchangers, fluid filters and/or filter systems, particularly gas and/or air filters and the like.

The workpieces exit the second treatment room 108 in a longitudinal direction through a sluice device 142 and are then on the drying conveyor path 126 shown as dash-dotted arrows. The embodiment according to FIG. 2 has four (parts of) conveyor paths 126.1-126.4 for the drying conveyor path. The first partial conveyor path 126.1 is designed as a longitudinal conveyor path with a longitudinal conveyor device. The boxes shown along the third partial conveyor path 126.3 or the third conveyor device 118 represent modules or cyclic positions at which the third conveyor device 118 briefly comes to a standstill during normal operation.

The third conveyor device 118 is preferably designed alternately as a longitudinal and transverse conveyor device on the partial conveyor paths 126.1-126.4, identified as the respective partial conveyor devices 118.1 to 118.4 of the third partial conveyor device 118.

From the first partial conveyor path 126.1, a workpiece is guided in longitudinal alignment into the first module or a first portion of the partial conveyor device 118.2 designed as a transverse conveyor device, which forms the second partial conveyor path 126.2. The workpiece is conveyed in a transverse direction along the partial conveyor path 126.2 and leaves this portion in a longitudinal direction without having to be rotated or turned. A transition to the third partial conveyor path 126.3 takes place without any further sluice device, by means of the third partial conveyor device 118.3, at the end of which a sluice device 142 is arranged. The three partial conveyor devices 118.1, 118.2 and 118.3, which are arranged between two sluice devices, extend within a drying room 110 to which heated air can be applied. After the second sluice device 142 arranged in the main conveying direction, the fourth partial conveyor path 126.4 follows, to which a workpiece can be fed in the longitudinal direction and along which the workpiece can be transported further in the transverse direction. In the last portion of the fourth partial conveyor device 126.4, the workpiece is again discharged in the longitudinal direction and transported away by means of conveyor means not shown. The fourth partial conveyor path 126.4 is preferably arranged within a (cooling) cooling room or a cooling device of a cooling area 150.

The main conveying direction extends like a meander in the example shown and bends several times by 90°. With each change of direction, the type of conveyor device also changes, namely from longitudinal to transverse conveyor device and vice versa. In this manner, the workpiece never has to be turned or rotated and, in particular, never has to be passed in a transverse orientation through a sluice device 142 or an entrance or exit of a treatment room. This design and method is particularly advantageous in terms of energy, particularly if the inlet and/or outlet cross-section of the sluice device 142 is adapted or adaptable to an external geometry of the workpieces.

As FIG. 2 further shows, it may be advantageous if all second partial conveyor paths 126.2 of the heating or heating area of all treatment lines 102 and/or all fourth partial conveyor paths 126.4 of the cooling area of all treatment lines 102, are each accommodated in a common treatment room. This is particularly advantageous in terms of energy. The individual portions of the partial conveyor paths intended for transverse conveying can be separated from one another by means of section walls 163. This is particularly advantageous if not all treatment lines 102 are operated.

In order to allow maximum accessibility to all elements of the drying conveyor 118 on the one hand and all supply and process elements 161 on the other hand, the latter are all arranged on the upper level E2.

As shown in FIG. 3, the first conveyor path 122 and the second conveyor path 124 extend along a common longitudinal axis 136 of the first treatment room 106 and the second treatment room 108.

However, at least part of the intermediate conveyor path 128 of the intermediate conveyor device 120 is laterally offset from the longitudinal axis 136 in the transverse direction 134.

For this purpose, the transverse conveyor device 120 comprises two transverse conveyor devices 140, by means of which the workpieces can be displaced in the transverse direction 134.

Within the intermediate treatment room 112, transverse conveying of the workpieces is therefore possible, in which the longitudinal axis of the workpiece is aligned transversely to the local conveying direction. As a result, the intermediate treatment room 112 and the intermediate conveyor device 120 can preferably be designed to be particularly compact. In addition, this allows the workpieces to be fed to the intermediate treatment room 112 and discharged from the intermediate treatment room 112 in the longitudinal orientation of the workpieces without requiring rotation of the workpieces, whereby, for example, a reduced cold air input and/or a reduced hot air discharge can be realized during a drying treatment within the intermediate treatment room 112.

Preferably, the treatment system 100 comprises a plurality of sluice devices 142. For example, an inlet sluice 144 is provided through which the workpieces can be conveyed into the intermediate treatment room 112. The inlet sluice 144 is particularly arranged at the first conveyor device 114. Preferably, the first conveyor device 114 extends through the inlet sluice 144 and into the intermediate treatment room 112.

A further sluice device 142 is preferably an outlet sluice 146 of the intermediate treatment room 112, which is arranged, for example, on the intermediate conveyor 120, preferably a longitudinal conveyor section segment of the intermediate conveyor 120.

By means of the intermediate conveyor 120, the workpieces can thus be discharged from the intermediate treatment room 112 through the outlet sluice 146.

The intermediate treatment room 112 is or comprises, in particular, a heating area 148 for heating the workpieces.

With respect to the intermediate conveyor path 128 downstream of the outlet sluice 146, a cooling area 150 for cooling the workpieces is preferably arranged.

In particular, the cooling area 150 is arranged at a transverse conveying direction 140 of the intermediate conveyor device 120, for example immediately before a transfer to the second conveyor device 116.

For example, the treatment system 100 can be operated in a continuous mode or in a cyclic operation. Further, alternatively or additionally, group operation can be provided for cyclical conveying or continuous conveying of groups of workpieces.

In cyclic operation, it may particularly be provided that the intermediate treatment room 112 comprises several cyclic positions and/or holding positions at which the workpieces remain for a short time, for example in order to be selectively exposed to tempered air by means of nozzles.

Optionally, it may be provided that a mechanical closing device for closing the intermediate treatment room 112, for example a sliding gate or rolling gate, is provided in the area of the inlet sluice 144 and/or the outlet sluice 146 and/or as an alternative to the respective sluice 144, 146.

For example, the cyclic positions and/or holding positions within the intermediate treatment room 112 may be associated with a common air feed, particularly with respect to a uniform heat supply at a plurality of cyclic positions and/or holding positions.

Alternatively or in addition to this, it may also be provided that several air guides, particularly recirculation air guides, for example with different heating effects, are provided for different cyclic positions and/or holding positions.

For example, two, three or four cyclic positions and/or holding positions are provided in the intermediate treatment room 112. For example, a run-in cycle, a heating cycle, a holding cycle and/or a transfer cycle can be provided.

The transfer cycle is, for example, a transfer cycle arranged within the intermediate treatment room 112, which is followed along the intermediate conveyor path 128 by the outlet sluice 146, wherein a further transfer cycle, particularly a cold transfer cycle, is subsequently provided, for example.

The transfer cycles particularly serve to transfer the workpieces from a transverse conveyor device 140 to a longitudinal conveyor device 152 of the intermediate conveyor device 120 and/or from the longitudinal conveyor device 152 to a transverse conveyor device 140.

A waiting place or waiting cycle may optionally be provided, for example, before the inlet sluice 144 or before the second conveyor device 116 and/or after the cooling area 150 (not separately represented in the figures).

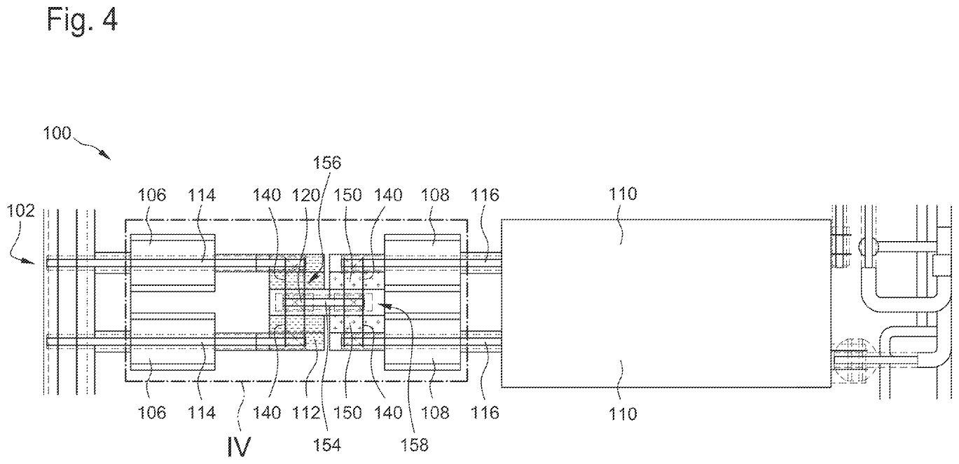

In FIG. 4, a further treatment line 102 of the treatment system 100 in accordance with FIG. 1 is shown.

In this treatment line 102, two first treatment rooms 106, two second treatment rooms 108 and a single intermediate treatment room 112 are provided. The two second treatment rooms 108 are each adjoined by a third treatment room 110.

The conveyor system 104 of the treatment line 102 in accordance with FIG. 4 comprises two first conveyor devices 114, by means of which the workpieces can be conveyed through the two first treatment rooms and introduced into the common intermediate treatment room 112.

In the common intermediate treatment room 112, the workpieces can be transferred to a common intermediate conveyor device 120, wherein the intermediate conveyor device 120 comprises two transverse conveyor devices 140 conveying in opposite directions in order to transfer the workpieces conveyed by the two first conveyor devices 114, for example alternately, to a common intermediate conveyor path segment 154 of the intermediate conveyor device 120. The intermediate conveyor path segment 154 is particularly part of or formed by a longitudinal conveyor device 152 of the intermediate conveyor device 120.

In particular, a combining device 156 for merging the workpieces is thus formed within the intermediate treatment room 112 by means of the intermediate conveying device 120, in particular in order to convey the workpieces from both first treatment rooms 106 in sections in a single row one behind the other.

The intermediate conveyor device 120 further preferably comprises a distribution device 158, by means of which the workpieces discharged from the intermediate treatment room 112 via the common intermediate conveyor path segment 154 can be distributed to the two second conveyor devices 116.

For this purpose, the distribution device 158 comprises, in particular, two further transverse conveyor devices 140, which connect the common intermediate conveyor path segment 154 to the second conveyor devices 116.

A cooling area 150 is preferably associated with each of these transverse conveyor devices 140, so that the workpieces can preferably be cooled before being fed to the respective second conveyor device 116.

Moreover, the embodiment of a treatment line 102 shown in FIG. 4 corresponds in terms of structure and function to the treatment line 102 shown in FIG. 3, so that reference is made to the above description in this respect.

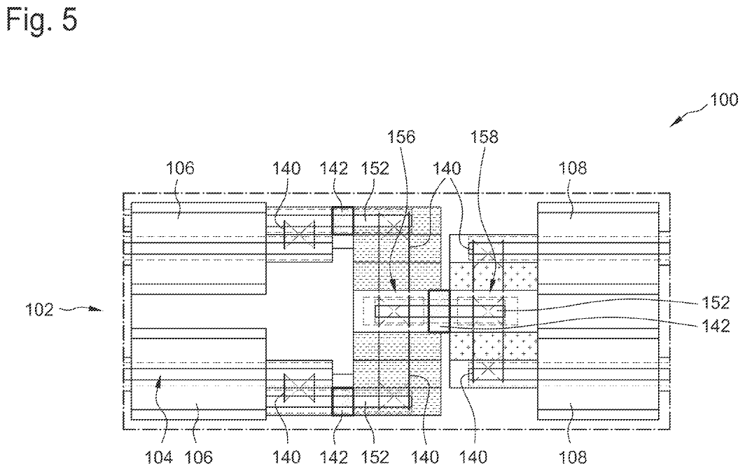

An alternative embodiment of a treatment system 100, particularly a treatment line 102, shown in FIG. 5 differs substantially from the embodiment shown in FIG. 4 in that the intermediate conveyor device 120 comprises two further transverse conveyor devices 140, i.e., a total of six transverse conveyor devices 140.

These further transverse conveyor devices 140 are particularly arranged between the respective first treatment room 106 and the inlet sluice 144 following it.

By means of these transverse conveyor devices 140, the workpieces can preferably be conveyed away from the common intermediate conveyor path segment 154 in the transverse direction 134 in order ultimately to increase the distance to the common intermediate conveyor path segment 154 and thus particularly to enable further cyclic positions and/or holding positions within the intermediate treatment room 112, preferably with identical distance between the first treatment rooms 106.

Moreover, the embodiment of the treatment system 100 shown in FIG. 5, in particular of a treatment line 102 of the treatment system 100, corresponds to the embodiment shown in FIG. 4, so that reference is made to the above description thereof in this respect.

In further embodiments of the treatment system 100 (not shown), individual or several features of the embodiments described above may be combined with one another. For example, an enlarged intermediate treatment room 112 can also be enabled in the treatment line 102 shown separately in FIG. 3 by the addition of a further transverse conveyor device 140.

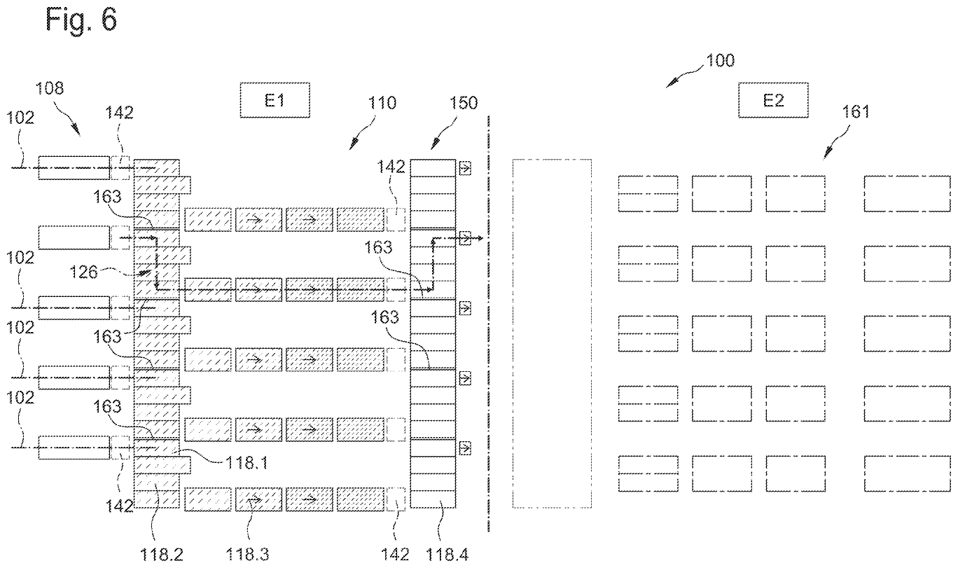

The exemplary embodiment shown in FIG. 6 differs from the exemplary embodiment shown in FIG. 2 in that there is no larger first longitudinal conveyor device or first longitudinal conveyor path 126.1, but the first partial conveyor device 118.1 is integrated in the first portion of the transverse conveyor device of the second partial conveyor path. A workpiece transported from the second treatment room 108 in a longitudinal orientation is introduced in this orientation through the sluice device 142 into the single portion or module of the first partial conveyor device 118.1 designed as a longitudinal conveyor device. This portion or module of the first partial conveyor device 118.1 is identical to the first portion or module of the second partial conveyor device 118.2 of the second partial conveyor path 126.2, which is designed as a transverse conveyor device. A transition portion of such a manner in which longitudinal and transverse conveying (or vice versa) of a workpiece takes place is referred to herein as a change module (or transition module) and is described as part of a transverse conveyor device. However, the change module can also be provided as part of a longitudinal conveyor or as an independent conveyor/module.

Analogous to FIG. 2, the fourth partial conveyor devices 118.4 form a common cooling area 150 and are arranged in a common cooling tunnel or cooling room.

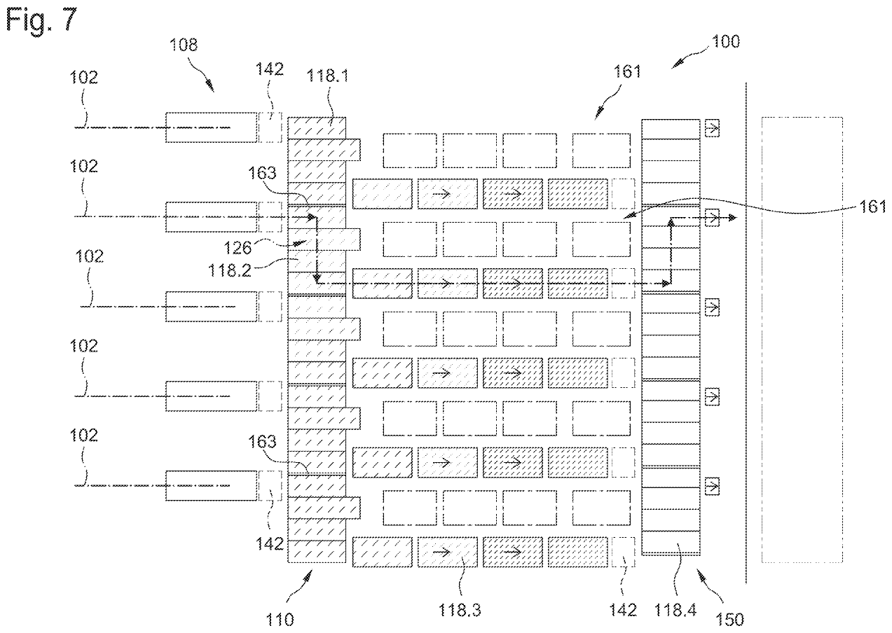

The embodiment according to FIG. 7 corresponds to the examples according to FIG. 2 and FIG. 6 with regard to the course of the third conveyor path, the drying conveyor path 126. In contrast to this, however, the supply and process elements 161 are arranged on the lower level E1, so that no complex support structure has to be provided for this. This installation variant is particularly advantageous if the supply and process elements 161 are of compact design, so that sufficient movement areas remain for maintenance and repair work. The variant is also suitable if, for example, a central heating and/or cooling device supplies all or most parts of the drying room, so that substantially valves and distribution devices must be provided along the treatment lines 102.

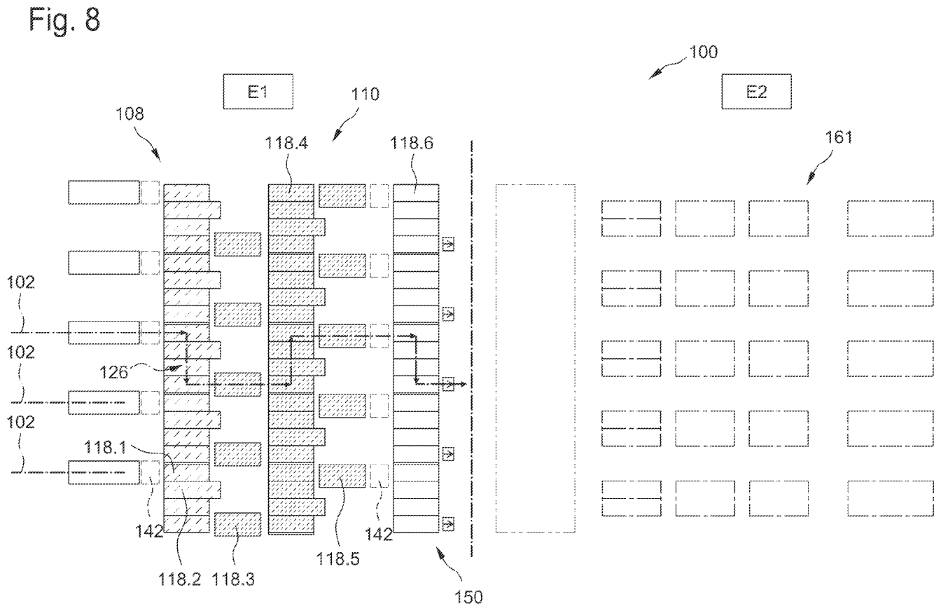

The example according to FIG. 8 is similar to that of FIG. 7, wherein six changes of direction are provided along the third conveyor path, the drying conveyor path 126. After the second treatment room 108, a workpiece is guided in longitudinal orientation through a sluice device 142 in longitudinal orientation into the change module of the second partial conveyor device 118.2. All second partial conveyor devices 118.2 are designed as transverse conveyor devices and are arranged within a common conveyor tunnel (not shown), which represents a heating or warming path. The partial conveyor devices 118.3 and 118.5, designed as longitudinal conveyor devices, with the fourth partial conveyor device 118.4 arranged between them and designed as a transverse conveyor device, form the main drying and/or heating room. A workpiece is introduced through the second sluice device 142 in the longitudinal direction into a change module of the sixth partial conveyor device 118.6 and transported in the transverse direction along the sixth partial conveyor path 126.6, particularly as far as the second change module. The workpiece is discharged from this in a longitudinal direction and leaves the cooling path or cooling zone.

Overall, a further sluice device can be provided after the cooling path or cooling zone as required, particularly depending on local conditions.

All or most of the supply and process elements 161 are arranged on the upper level E2 in the embodiment in accordance with FIG. 8.

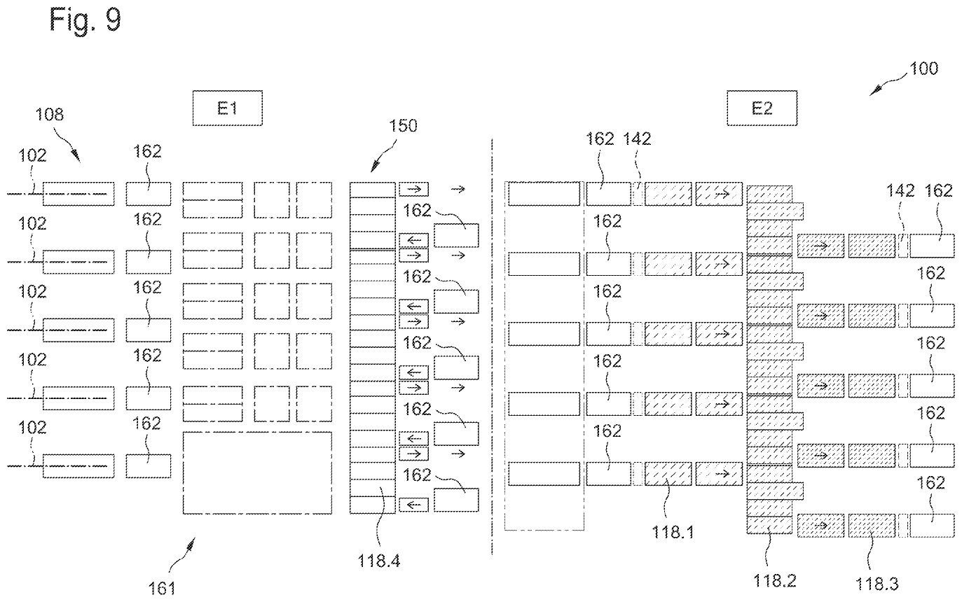

In the embodiment according to FIG. 9, the third conveyor path, the drying conveyor path 126, is distributed over both levels E1, E2. For this purpose, a lifting system 162 is provided at the exit of the second treatment room 108, or the associated second conveyor device 116, by means of which the workpieces are lifted from the lower level E1 to the upper level E2. These can generally be all types of vertical conveyors, elevator systems and/or lifting or crane devices. The first partial conveyor device 118.1, designed as a longitudinal conveyor device, and the subsequent second partial conveyor device 118.2, designed as a transverse conveyor device, form the warming or heating path. The subsequent third partial conveyor path 118.3 (longitudinal conveyor path) is the heating path, which leaves a workpiece in a longitudinal direction through the sluice device 142. A further lifting system 162 is provided downstream of the sluice device 142, with which workpieces can be moved back to the lower level E1.

A common cooling path or cooling zone for the fourth partial conveyor device 118.4 is arranged along the lifting systems 162, which are arranged in alignment and/or parallel to one another, on the lower level E1, into which workpieces are inserted in the longitudinal direction, passed through in the transverse direction and conveyed out at the change module in the longitudinal direction.

The supply and process elements 161 are arranged on the lower level E1 between the lifting systems 162 arranged at the beginning and the cooling path/zone designed as a cooling tunnel.

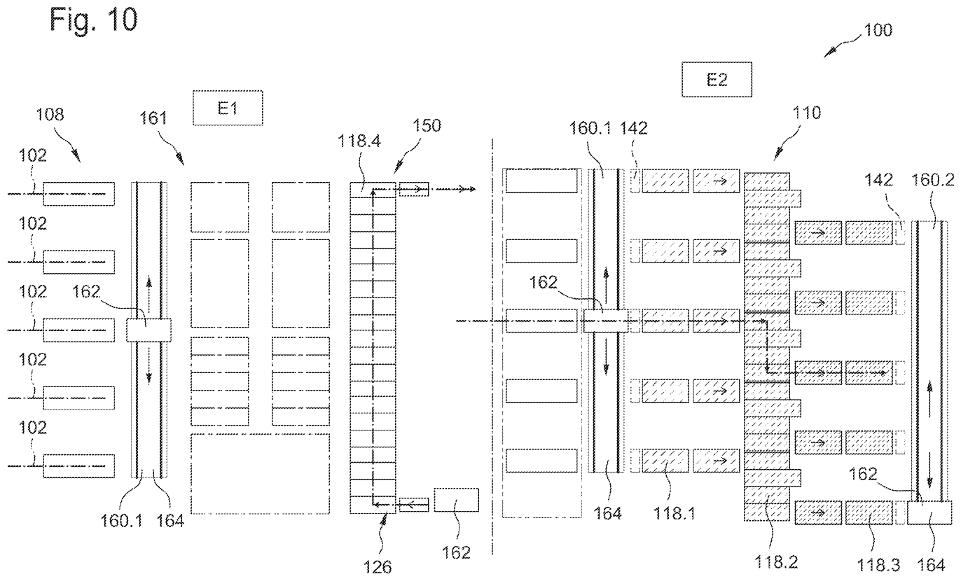

In FIG. 10, a treatment system 100 is represented in which the cooling path/zone is arranged on the lower level E1, analogous to FIG. 9, and the heating and heating section is arranged on the second level E2. The difference is that for all treatment lines 102, only one lifting system 162 is provided for lifting and one lifting system 162 is provided for lowering workpieces between levels E1, E2. Here, the lifting systems 162 are arranged on a first and on a second transverse displacement unit 164.

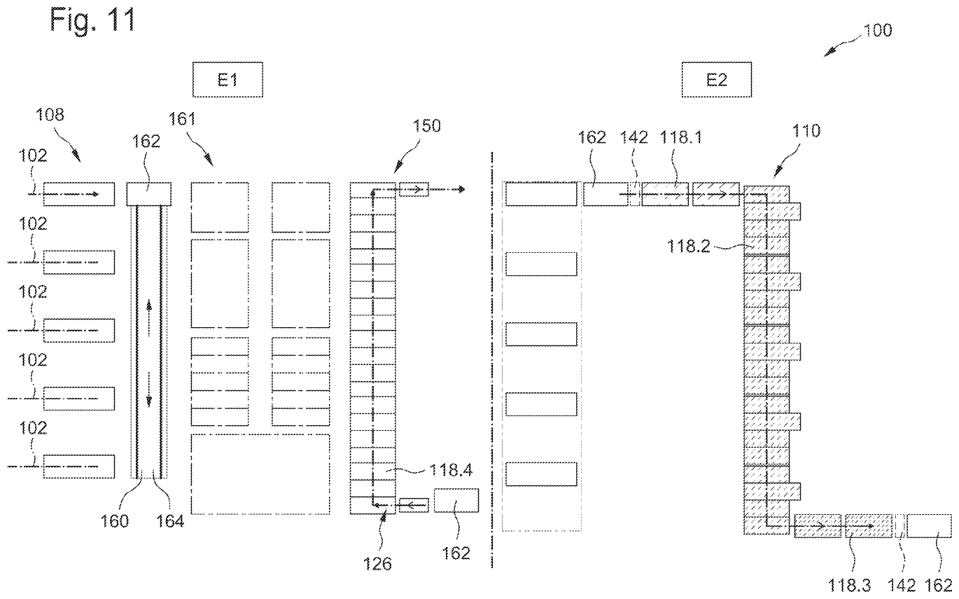

In the embodiment of FIG. 11, all workpieces are directed to a single, identical drying path 126. Here, workpieces are sequentially removed from the individual treatment lines 102 and conveyed to the upper level 2 via a lifting system 162 retractable on the transverse displacement unit 164 and there transported in longitudinal alignment through a sluice device 142 to a single, common drying path 126. The cooling path or cooling zone is arranged on the lower level E1 in the same way as FIG. 10, for example, and the workpieces are also fed in the same manner, but only via a single change module.

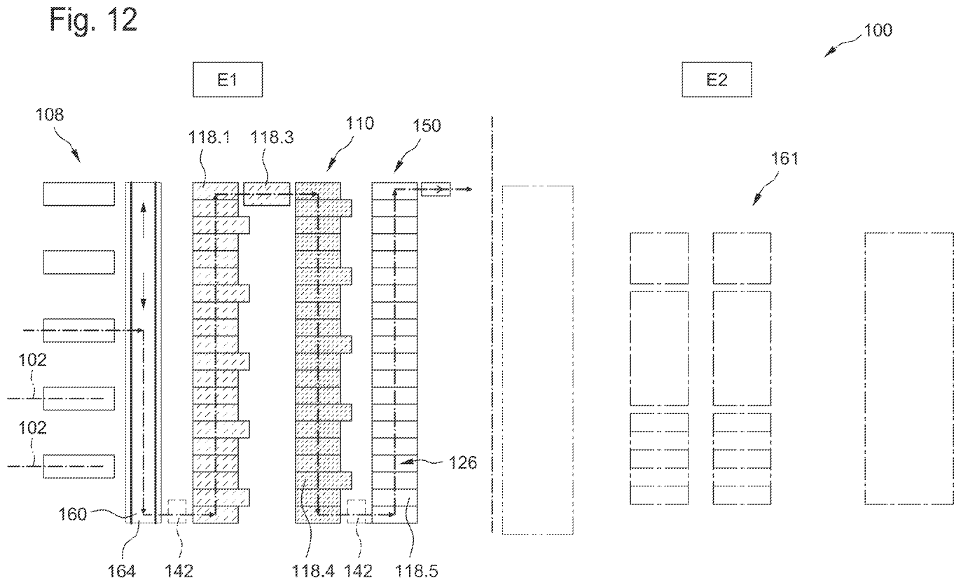

FIG. 12 shows a variant of the treatment system 100 similar to FIG. 11, wherein all partial paths of the drying path 126 and all parts of the third conveyor devices 118 are arranged on the lower level E1. The sequential introduction of the workpieces in longitudinal alignment is carried out in the same manner. This design is structurally easy to realize and therefore economically advantageous. The supply and process elements 161 are arranged on the upper level E2.

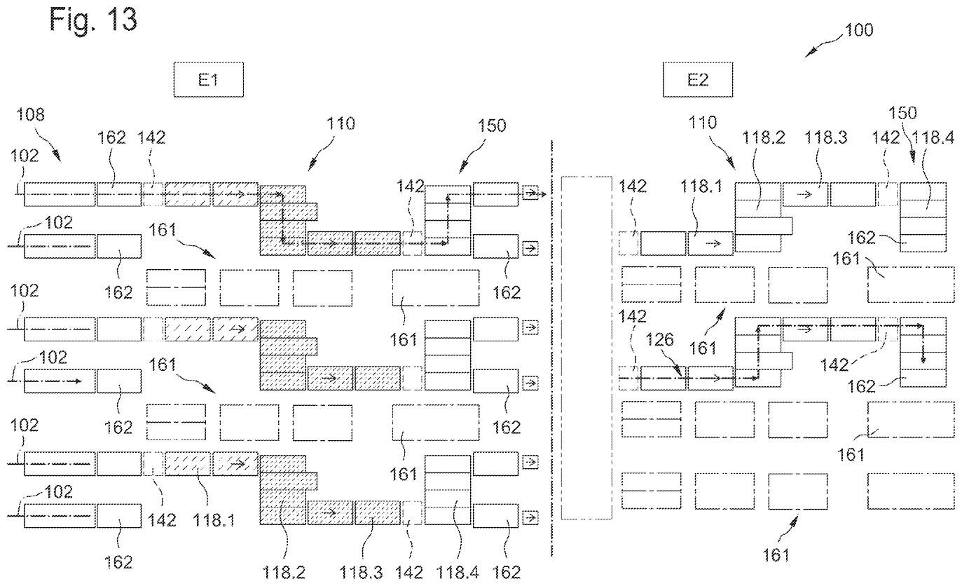

The variant according to FIG. 13 is similar to the embodiment according to FIG. 9, wherein, however, lifting systems 162 are only assigned to some treatment lines. The difference is that for part of the treatment lines 102, the respective drying path 126 is guided completely on the lower level E1 and for two of the treatment lines 102, the drying paths 126 are arranged on the upper level E2, which can be achieved in an analogous manner to the embodiment in accordance with FIG. 9 via lifting systems 162.

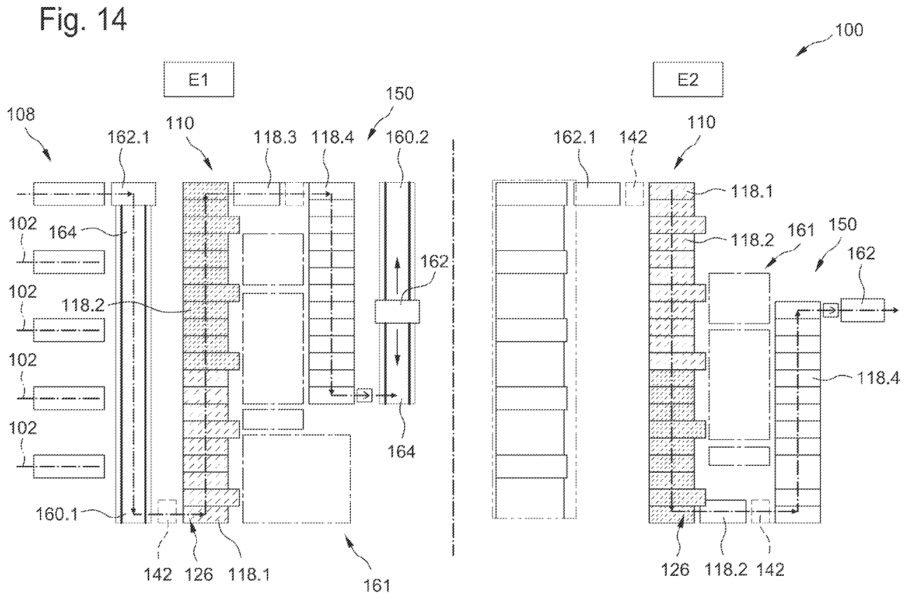

In the embodiment according to FIG. 14, analogous to the embodiment according to FIG. 12, the workpieces only pass through a single drying path 126, wherein the loading takes place sequentially via the transverse displacement unit 164 and/or transport means retractable there. In contrast to the embodiment according to FIG. 12, two complete drying paths 126 with associated sluice devices 142 are provided on each of the two levels E1, E2.

The partial conveyor devices are represented as boxes with the respective cycle portions. A total of four to six cycle paths are provided for the heating or warming portion, for example, and at least two cycle paths for the heating or holding path.

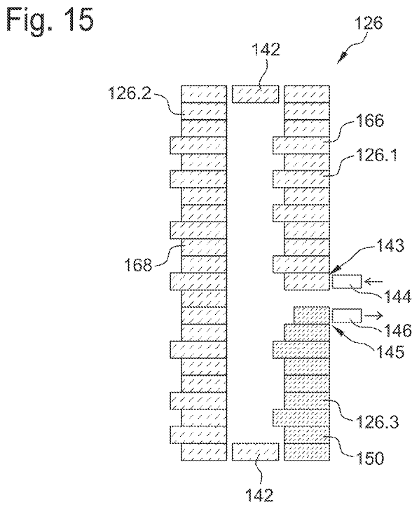

An alternative embodiment of a drying conveyor path 126 shown in FIG. 15 is particularly designed to be substantially annularly closed, wherein a feed and a discharge of the workpieces are at least approximately adjacent to one another.

The drying conveyor path 126 in accordance with FIG. 15 comprises a first partial conveyor path 126.1, a second partial conveyor path 126.2 and a third partial conveyor path 126.3, wherein all three partial conveyor paths are arranged parallel to one another and/or wherein the first partial conveyor path 126.1 and the second partial conveyor path 126.3 adjoin one another and/or have a common main axis of extension.

Here, it is particularly provided that an inlet area 143 or feed area, in particular an inlet sluice 144, for feeding workpieces to the first partial conveyor path 126.1 is arranged at an end of the first partial conveyor path 126.1 facing the third partial conveyor path 126.3.

Alternatively or in addition to this, it may be provided that an outlet area 145 or discharge area, particularly an outlet sluice 146, for discharging workpieces from the third partial conveyor path 126.3 is arranged at an end of the third partial conveyor path 126.3 facing the first partial conveyor path 126.1.

It may be favorable if the first partial conveyor path 126.1 is a component of a pre-dryer 166 or forms a pre-dryer 166; and/or if the second partial conveyor path 126.2 is a component of a main dryer 168 or forms a main dryer 168; and/or if the third partial conveyor path 126.3 is a component of a cooling area 150, in particular a cooling zone, or forms a cooling area 150, in particular a cooling zone.

The drying conveyor path 126 is preferably dimensioned in such a manner that a total length of the first partial conveyor path 126.1 plus a total length of the third partial conveyor path 126.3 corresponds at least approximately to a total length of the second partial conveyor path 126.2. In particular, the total length of the first partial conveyor path 126.1 plus the total length of the third partial conveyor path 126.3 is at least about 70%, for example at least about 85%, and/or at most about 100%, for example at most about 95%, of the total length of the second partial conveyor path 126.2.

The inlet area 143 or feed area, in particular the inlet sluice 144, for feeding workpieces to the first partial conveyor path 126.1 and the outlet area 145 or discharge area, in particular the outlet sluice 146, for discharging workpieces from the third partial conveyor path 126.3 are preferably arranged directly next to one another and/or consecutively with respect to a conveying direction of the workpieces in the first partial conveyor path 126.1 and/or the third partial conveyor path 126.3.

The workpieces are preferably fed to the first partial conveyor path 126.1 and/or removed from the third partial conveyor path 126.3 in a direction which is at least approximately perpendicular to a conveying direction of the workpieces in the first partial conveyor path 126.1 and/or the third partial conveyor path 126.3.

The workpieces are preferably conveyed in a transverse orientation in the first partial conveyor path 126.1, the second partial conveyor path 126.2 and the third partial conveyor path 126.3.

The conveying directions in the first partial conveyor path 126.1 and the third partial conveyor path 126.3 are preferably parallel to each other and/or in the same direction, while the conveying direction in the second partial conveyor path 126.2 is preferably antiparallel and/or in the opposite direction.

A sluice device 142 may optionally be arranged between the first partial conveyor path 126.1 and the second partial conveyor path 126.2, particularly an intermediate sluice.

Further, a sluice device 142 may optionally be arranged between the second partial conveyor path 126.2 and the third partial conveyor path 126.3, particularly an intermediate sluice.

In a further development, it may also be provided that a flash-off conveyor section (not shown) is arranged directly next to the first partial conveyor section 126.1 and/or antiparallel thereto. This can lead to a particularly compact design.

Otherwise, the design of the drying conveyor path 126 shown in FIG. 15 corresponds to the embodiments described above in terms of structure and function, so that reference is made to their description in this regard.

### LIST OF REFERENCE SIGNS

100 Treatment system
102 treatment line
104 conveyor system
106 first treatment room
108 second treatment room
110 third treatment room
112 intermediate treatment room
114 first partial conveyor device
116 second partial conveyor device
118 third partial conveyor device
120 intermediate conveyor device
122 first conveyor path
124 second conveyor path
126 third conveyor path/drying conveyor path
126.1 first partial conveyor path
126.2 second partial conveyor path
126.3 third partial conveyor path
126.4 fourth partial conveyor path
128 intermediate conveyor path
130 rotation device
132 Main conveyor direction
134 Transverse direction
136 longitudinal axis
138 main extension direction
140 transverse conveyor device
142 sluice device
143 inlet area
144 inlet sluice
145 outlet area
146 outlet sluice
148 heating area
150 cooling area
152 longitudinal conveyor device
154 intermediate conveyor path segment
156 Combining device
158 distribution device
160 transverse distribution device, also 160.1, 160.2, 160.3
161 supply and process elements
162 lifting system
163 section walls
164 transverse displacement unit
166 pre-dryer
168 main dryer
E1, E2 level

1. A treatment system comprising a treatment line, the treatment line including:
a single-part or multi-part drying room for drying and/or curing coated workpieces, wherein the workpieces optionally have a larger longitudinal extension and a smaller transverse extension in comparison thereto, and
a conveyor system which includes an at least two-part drying conveyor device which extends along an at least two-part drying conveyor path,
wherein the drying conveyor path has at least two partial conveyor paths and, wherein a first partial conveyor path has a first partial conveyor device, which is optionally designed as a longitudinal conveyor device, and wherein a second partial conveyor path has a second partial conveyor device, which is optionally designed as a transverse conveyor device.

2. The treatment system according to claim 1, wherein the drying conveyor path includes a third partial conveyor path which has a third partial conveyor device, wherein the third partial conveyor device is designed as a longitudinal conveyor device.

3. The treatment system according to claim 1, wherein the drying conveyor path includes a fourth partial conveyor path which has a fourth partial conveyor device, wherein the fourth partial conveyor device is designed as a transverse conveyor device, wherein the fourth partial conveyor device is optionally arranged in a space designed as a cooling room or a space designed as a cooling device.

4. The treatment system according to claim 1, wherein a lifting system for workpieces is
a) a part of the first partial conveyor device,
b) a part of the second partial conveyor device,
c) a part of the third partial conveyor device, and/or
d) a part of the fourth partial conveyor device.

5. The treatment system according to claim 1, wherein the treatment system includes at least two treatment lines, which each including:
a) one or more treatment rooms,
b) one or more partial conveyor devices designed as longitudinal conveyor devices, and
c) one or more partial conveyor devices designed as transverse conveyor devices,
wherein at least two or all of the partial conveyor devices of the treatment lines, which are designed as longitudinal conveyor devices, are arranged and/or aligned parallel to one another and/or
wherein at least two or all of the partial conveyor devices designed as transverse conveyor devices are arranged in a common partial portion of the at least two treatment rooms and/or drying rooms.

6. The treatment system according to claim 5, wherein the at least two of the partial conveyor devices designed as transverse conveyor devices are arranged on two vertically spaced planes.

7. The treatment system according to claim 5, wherein the common partial portion, in which a plurality of transverse conveyor devices are arranged, has at least one section wall, with which the common partial portion can be divided off, optionally for delimiting a treatment line from an adjacent treatment line.

8. The treatment system according to claim 1, wherein a sluice is provided which is arranged
a) upstream of the first partial conveyor device designed as a longitudinal conveyor device; and/or
b) downstream of a last partial conveyor device designed as a longitudinal conveyor device.

9. The treatment system according to claim 1, wherein the partial conveyor device designed as a transverse conveyor device
a) has at least one input module, into which a workpiece can be introduced oriented in the longitudinal direction and can be transported out and/or on along the partial conveyor path oriented in the transverse direction; and/or
b) has an output module, into which a workpiece can be introduced oriented in the transverse direction and can be transported out and/or onward oriented in the longitudinal direction, wherein the input module or the output module forms part or the only part of a longitudinal conveyor device.

10. The treatment system for treating workpieces according to claim 1, wherein the following is arranged upstream of the drying room with respect to the conveying direction:
a first treatment room for performing a first treatment step on the workpieces;
a second treatment room for performing a second treatment step on the workpieces;
an intermediate treatment room for implementing an intermediate treatment between the first treatment step and the second treatment step; and
a conveyor system by which the workpieces can be removed from the first treatment room, passed through the intermediate treatment room and/or fed to the second treatment room.

11. The treatment system according to claim 1, wherein the drying room is arranged as a third treatment room downstream of the at least one second treatment room with respect to the conveying direction, wherein one or more treatment devices for treating the workpieces are assigned to the third treatment room,
a) wherein, for example, one or more nozzles are provided as a treatment device for flowing a tempered gas stream, for example air, onto the workpieces; and/or
b) wherein the workpieces are treated or can be treated by exposing them to a tempered gas stream, for example air, wherein the tempered gas stream or the air is supplied or can be supplied to the workpieces via a filter ceiling and/or via a plenum, wherein optionally the tempered gas stream supplied in this manner, for example air, is discharged or can be discharged preferably via a bottom-side extraction system.

12. The treatment system according to claim 1, wherein
a) after the drying room as the third treatment room or
b) a cooling area, optionally a cooling room or a cooling zone, is provided as a component of the drying room, wherein nozzles are provided in the cooling area optionally for flowing a tempered gas stream, for example a heated gas stream and/or a cooled gas stream, optionally air, onto the workpieces, wherein the gas stream supplied in this way is preferably discharged or can be discharged via a bottom-side extraction system.

13. The treatment system according to claim 1, wherein upstream of the drying room and
a) after the second treatment room and/or
b) after the end of the second conveyor device and/or the second conveyor path,
a rotation device is provided by which a workpiece can be rotated from a longitudinal orientation to a transverse orientation.

14. The treatment system according to claim 1, wherein
a) the conveyor system includes a first conveyor device for conveying the workpieces along a first conveyor path through the first treatment room and/or out of the first treatment room,
a1) wherein the first conveyor device is designed as a rail or chain conveyor and has at least one holding and/or carrying device for a workpiece, optionally a plurality of holding and/or carrying devices for one workpiece each, wherein the first conveyor device includes at least one endlessly circulating, motor-driven conveyor chain; and/or
a2) wherein the first conveyor device includes at least one autonomous and/or self-propelled transport vehicle for moving at least one holding and/or carrying device for one or more workpieces; and/or
b) that the conveyor system includes a second conveyor device for conveying the workpieces along a second conveyor path into the second treatment room and/or through the second treatment room,
b1) wherein the second conveyor device is designed as a rail or chain conveyor and has at least one holding and/or carrying device for a workpiece, optionally a plurality of holding and/or carrying devices for one workpiece each, wherein the second conveyor device includes at least one endlessly circulating, motor-driven conveyor chain; and/or
b2) wherein the second conveyor device includes at least one autonomous and/or self-propelled transport vehicle for moving at least one holding and/or carrying device for one or more workpieces; and/or
c) that the conveyor system includes an intermediate conveyor device by which the workpieces can be conveyed through an intermediate treatment room and/or from the first conveyor device to the second conveyor device,
c1) wherein the intermediate conveying device is designed as a rail or chain conveyor and has at least one holding and/or carrying device for a workpiece, optionally a plurality of holding and/or carrying devices for one workpiece each, wherein the intermediate conveying device includes at least one endlessly circulating, motor-driven conveyor chain; and/or
c2) wherein the intermediate conveying device includes at least one autonomous and/or self-propelled transport vehicle for moving at least one holding and/or carrying device for one or more workpieces.

15. The treatment system according to claim 10, wherein, by an intermediate conveyor device, the workpieces can be conveyed at least in portions along an intermediate conveyor path which extends at least in portions
at least approximately parallel to the first conveyor path of the first conveyor device; and/or
a) extends at least approximately parallel to the second conveyor path of the second conveyor device; and/or
b) is arranged offset to the first conveyor path of the first conveyor device and/or to the second conveyor path of the second conveyor device in a transverse direction extending perpendicularly to a main conveying direction of the conveyor system, wherein preferably at least one transverse conveyor device is provided, by which a workpiece can be transferred from the first conveyor device to the intermediate conveyor device and/or a longitudinal conveyor device and/or by which a workpiece can be transferred from the intermediate conveyor device to the second conveyor device.

16. The treatment system (100) according to claim 10, wherein
a) a holding and/or carrying device of the first conveyor device is arranged on a rotating and tilting unit for workpieces and/or has such a unit, optionally a rotating and tilting unit for rotating the workpieces, for example by at least 180°, about a horizontal axis of rotation which is oriented in the transverse direction, and for conveying the workpieces over a partial path in an orientation rotated, for example, by 180°; and/or
b) the holding and/or carrying device of the second conveyor device is arranged on a rotating and tilting unit for workpieces and/or has such a unit, optionally a rotating and tilting unit for rotating the workpieces, for example by at least 180°, about a horizontal axis of rotation which is oriented in the transverse direction, and for conveying the workpieces over a partial path in an orientation rotated, for example, by 180°.

17. The treatment system according to any of claim 10, wherein the first conveyor path of the first conveyor device and the second conveyor path of the second conveyor device
a) extend parallel to one another; and/or
b) extend parallel to a main conveying direction of the conveyor system and/or predetermine it, for example together; and/or
c) are arranged consecutively and/or in alignment with one another along a main conveying direction of the conveyor system.

18. The treatment system according to claim 10, wherein the first conveyor device extends into the intermediate treatment room, for example linearly along the main conveying direction of the conveyor system.

19. The treatment system according to claim 10, wherein the intermediate conveyor device includes an intermediate conveyor path, which includes a plurality of intermediate conveyor path segments extending transversely to one another.

20. The treatment system according to claim 19, wherein
a) a transverse conveyor device is provided between the end of the first conveyor device and the beginning of the intermediate conveyor device or a longitudinal conveyor device; and/or
b) a transverse conveyor device is provided at the end of the intermediate conveyor device and the beginning of the second conveyor device.

21. The treatment system according to claim 10, wherein
a) the treatment system includes at least one coating device, which is arranged in the first treatment room and is used for performing a coating process for treating the workpieces, wherein the coating device in the first treatment room is a spray painting device, optionally a spray painting device having spraying and/or painting robots; and/or
b) the treatment system includes at least one coating device, which is arranged in the second treatment room and is used for performing a coating process for treating the workpieces, wherein the coating device in the second treatment room is a spray painting device, optionally a spray painting device having spraying and/or painting robots; and/or
c) the intermediate treatment room is or includes a tempering and/or drying room for tempering and/or drying the workpieces.

22. The treatment system according to claim 10, wherein
a) the treatment system includes at least one pretreatment device which is arranged in the first treatment room or is arranged upstream of the first treatment room with respect to the conveying direction and serves to perform a pretreatment of the workpieces, wherein the pretreatment device is, for example, a cleaning device, a degreasing device and/or a phosphating device; and
b) the treatment system includes at least one coating device, which is arranged in the second treatment room and is used for performing a coating process for treating the workpieces, wherein the coating device in the second treatment room is a spray painting device, optionally a spray painting device having spraying and/or painting robots:
c) the intermediate treatment room is or includes a tempering and/or drying room for tempering and/or drying the workpieces.

23. The treatment system according to claim 10, wherein
a) the treatment system includes at least one coating device, which is arranged in the first treatment room and is used for performing a coating process for treating the workpieces, wherein the coating device in the first treatment room is a spray painting device, optionally a spray painting device having spraying and/or painting robots; and/or
b) the treatment system includes at least one coating device, which is arranged in the second treatment room and is used for performing a coating process for treating the workpieces, wherein the coating device in the second treatment room is a spray painting device, optionally a spray painting device having spraying and/or painting robots;
wherein the spray painting device in the first treatment room is used to apply a basecoat and wherein the spray painting device in the second treatment room is used to apply a clearcoat.

24. The treatment system according to claim 10, wherein at least one coating device is arranged in the first treatment room and/or in the second treatment room, which coating device is used for performing a coating process for treating the workpieces, wherein the coating device is a spray painting device, optionally a spray painting device having spraying and/or painting robots, and wherein a coating device in the first treatment room and/or a coating device in the second treatment room is connected to a metering and preparation unit for at least two coating fluids.

25. The treatment system according to claim 10, wherein the intermediate treatment room includes a plurality of cyclic positions and/or holding positions for temporarily positioning the workpieces,
wherein one or more treatment devices for treating the workpieces are assigned to one or more of the cyclic positions and/or holding positions, for example one or more nozzles for supplying the workpieces with a tempered gas stream, wherein the gas stream supplied in this way is preferably discharged or can be discharged via a bottom-side extraction system.

26. The treatment system according to claim 10, wherein
a) a sluice device and/or a barrier, for example mechanical and/or openable and/or closable, is arranged between the first treatment room and the intermediate treatment room and/or
b) between the intermediate treatment room and the second treatment room.

27. The treatment system according to claim 26, wherein the sluice device, which is arranged between the first treatment room and the intermediate treatment room, and/or the sluice device, which is arranged between the intermediate treatment room and the second treatment room, is a longitudinal sluice device through which the workpieces can be conveyed in a longitudinal arrangement thereof, optionally a sluice device and/or barrier which, in the open state, is adapted or adaptable to the outer contour of the workpieces.

28. The treatment system according to claim 10, wherein
a) after the intermediate treatment room and before the second treatment room, or
b) a cooling area, optionally a cooling room or a cooling zone,
is provided as a component of the intermediate treatment room,
wherein nozzles are optionally provided in the cooling area for supplying the workpieces with a tempered gas flow, for example a heated gas flow and/or a cooled gas flow, optionally air, wherein the gas flow supplied in this way is preferably discharged or can be discharged via a bottom-side extraction system.

29. The treatment system according to claim 10, wherein in the intermediate treatment room, optionally immediately following an inlet sluice, the workpieces are or can be treated by exposing them to tempered air, wherein the tempered air is or can be supplied to the workpieces via a filter ceiling and/or via a plenum, the air supplied in this way preferably being or can be discharged via a floor-side extraction system.

30. The treatment system according to claim 10, wherein the treatment system includes two or more than two first treatment rooms with which a single intermediate treatment room is associated, for example downstream, optionally an intermediate treatment room arranged centrally between two first treatment rooms.

31. The treatment system according to claim 10, wherein
a) that the treatment system has two or more than two inlet sluices through which the workpieces can be conveyed into the intermediate treatment room; and/or
b) that the treatment system has a single outlet sluice through which the workpieces can be conveyed out of the intermediate treatment room.

32. The treatment system according to claim 10, wherein the conveyor system (104) includes a combining device, by which the workpieces from a plurality of first treatment rooms can be combined and fed to a common conveyor path segment, for example an intermediate conveyor path segment of an intermediate conveyor path, wherein the combining device is arranged, for example, within the intermediate treatment room.

33. The treatment system according to claim 10, wherein the conveyor system includes a distribution device, by which the workpieces can be distributed from an intermediate treatment room, for example from an intermediate conveyor path segment of an intermediate conveyor path, to a plurality of second treatment rooms, for example a plurality of second conveyor devices.

34. The treatment system according to claim 1, wherein the drying conveyor path includes a first partial conveyor path, a second partial conveyor path and a third partial conveyor path, wherein all three partial conveyor paths are arranged parallel to one another and wherein the first partial conveyor path and the second partial conveyor path are adjacent to one another and/or have a common main axis of extension.

35. The treatment system according to claim 34, wherein
a) an inlet area or feed area, optionally an inlet sluice, for feeding workpieces to the first partial conveyor path is arranged at an end of the first partial conveyor path facing the third partial conveyor path and/or
b) an outlet area or discharge area, optionally an outlet sluice, for discharging workpieces from the third partial conveyor path is arranged at an end of the third partial conveyor path facing the first partial conveyor path.

36. The treatment system according to claim 34, wherein
a) the first partial conveyor path is part of a pre-dryer or forms a pre-dryer; and/or
b) the second partial conveyor path is part of a main dryer or forms a main dryer; and/or
c) the third partial conveyor path is part of a cooling area, optionally a cooling zone, or forms a cooling area, optionally a cooling zone.

37. The treatment system according to claim 34, wherein a total length of the first partial conveyor path plus a total length of the third partial conveyor path corresponds at least approximately to a total length of the second partial conveyor path.

38. A method for drying and/or curing coated workpieces, which optionally have a larger longitudinal extension and a smaller transverse extension in comparison thereto, optionally vehicle bodies, vehicle chassis or similar, wherein a treatment system according to claim 1 is used for the final drying step.

39. The method according to claim 38, wherein the workpieces are coated at least partially, optionally over an entire surface thereof, and/or at least once with at least one coating fluid.

40. The method according to claim 38, wherein the method further includes:
a) performing a first treatment step on the workpieces in a first treatment room;
b) performing a second treatment step on the workpieces in a second treatment room;
c) performing an intermediate treatment between the first treatment step and the second treatment step in an intermediate treatment room,
wherein the workpieces are removed from the first treatment room by a conveyor system, passed through the intermediate treatment room and/or fed to the second treatment room.

41. The method for treating workpieces according to claim 38, wherein, prior to performing the first treatment step in the first treatment room, a pretreatment step is performed on the workpiece, wherein the pretreatment step includes cleaning, degreasing and/or phosphating.

42. The method for treating workpieces according to claim 38, wherein a, optionally final, drying step is carried out in a plurality of substeps, including:
a) a warming step,
b) a warming or holding step and
c) a cooling step,
wherein optionally the workpiece is flowed against with a tempered and/or treated gas stream, for example air.

43. The method for treating workpieces according to claim 42, wherein, in the drying step, the workpiece is flowed against in the partial steps at different flow speeds, optionally
a) in the warming step at least for a partial path and/or partial duration with a flow speed of at least about 5 meters per second (m/s) and/or at most about 14 m/s and/or
b) in the heating or holding step at least for a partial path and/or partial duration with a flow speed of at least approximately 15 m/s and/or at most approximately 25 m/s.

44. The method for treating workpieces according to claim 42, wherein the following is provided in at least one substep of the drying step:
a) in the warming, at least for a partial path and/or partial duration, a heating air input with a temperature of at least approximately 100° C. and/or at most approximately 120° C., for example between 105° C. and 115° C.; and/or
b) in the heating or holding step, at least for a partial path and/or partial duration, heating air is introduced at a temperature of at least approximately 135° C. and/or at most approximately 155° C., for example between 140° C. and 150° C.
